(19) United States
(12) Patent Application Publication
(10) Pub. No.: US 2004/0233153 A1
(43) Pub. Date: Nov. 25, 2004

(54) Communication device with automatic display and lighting activation and method therefore

(76) Inventor: Heber Robinson, W. Palm Beach, FL (US)

Correspondence Address: Randi L. Dulaney, Motorola, Inc., Law Department, 8000 West Sunrise Boulevard, Fort Lauderdale, FL, 33322, US

(21) Appl. No.: 10/443,218

(22) Filed: May 22, 2003

(51) Int. Cl. G09G 3/36

(52) U.S. Cl. 345/102

(57) ABSTRACT

A communication device (100) includes a sensor (125) for determining a position of the communication device (100) in relation to a device user, a user interface (250) for receiving user inputs from the device user; and a lighting mechanism (260) for illuminating the user interface (250) when the position determined by the sensor (125) is greater than a predetermined distance.

### BACKGROUND OF THE INVENTION

1. Field of the Invention

This invention relates in general to electronic devices and more particularly to communication devices with display and lighting capability.

2. Description of the Related Art

Cellular telephones, messaging devices, PDAs (Personal Digital Assistants) and other portable electronic devices having communication capability have become fixtures of everyday life over the last several years. As they evolve, prices continue to fall while the devices' capabilities have expanded. It is anticipated that as time goes by, the capabilities of such communication devices will continue to expand as prices continue to fall, making use of such communication devices a permanent part of people's daily lives. Device users utilize such communication devices at all times of the day or night and in all types of locations.

Included in the operational features of many communication devices are lighting capabilities such as display backlighting and keypad lighting. Such lighting gives the device user the ability to interact with the communication device in various situations including dark locations such as at night and in a darkened room. Upon pressing of a button on the keypad, initiating or receiving a communication signal, or other similar user interactions, the lighting of the display and/or the keypad is activated. The various lighting operations available to the device user are typically pre-programmed by the manufacturer and stored in the communication device. Some communication devices today also provide for device user manual programming of lighting operations. Conventional lighting includes illumination of one or more light emitting diodes (LEDs) or lamps individually or in conjunction with a control button. Other lighting options include the use of electroluminescent technology.

One negative effect of the lighting capability is the drain on battery life associated therewith. Accordingly, many communication devices include timers which selectively turn off the lighting after a predetermined period of operation. Similarly, many communication devices are programmed to turn off the device lighting upon completion of a communication such as a telephone call.

One drawback to timer operation of the lighting capability and the automatic turning off of the lighting operation in response to various functions of the communication device is that when this occurs in a dimly lit or dark environment, the user may not be able to see the display or keypad. (i.e. detracting from the original purpose of the lighting). Users may need the lighted keypad during a call to look at the display, to find a button to terminate the call, and the like. To reactivate the lighting, the device user “blindly” presses a button on the keypad. Dependent upon the operation of the button pressed, undesirable operations can be unintentionally implemented. For example, during a telephone call, in order to reactivate the lighting, the device user may unintentionally press the end button or create an undesirable tone(s) the party on the other end of the call will hear.

Further included in the operational features of many communication devices is display capability. The display can be, for example, a liquid crystal display utilized to display text, graphics, and the like. In an effort to save battery life of the portable electronic device and to prevent a phenomenon called “burn-in”, display screen savers are utilized. Many screen savers completely blank the display area by removing all signals from the display, resulting in a blank display. When a device user desires and/or requires reactivating of the display, undesirable operations such as described above in reference to the lighting functions can occur when operating within a dark environment.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 illustrates an exemplary embodiment of a communication device.

FIG. 2 is an electronic block diagram of the communication device of FIG. 1.

FIG. 3 is a flowchart illustrating one embodiment of the operation of the communication device of FIGS. 1 and 2.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

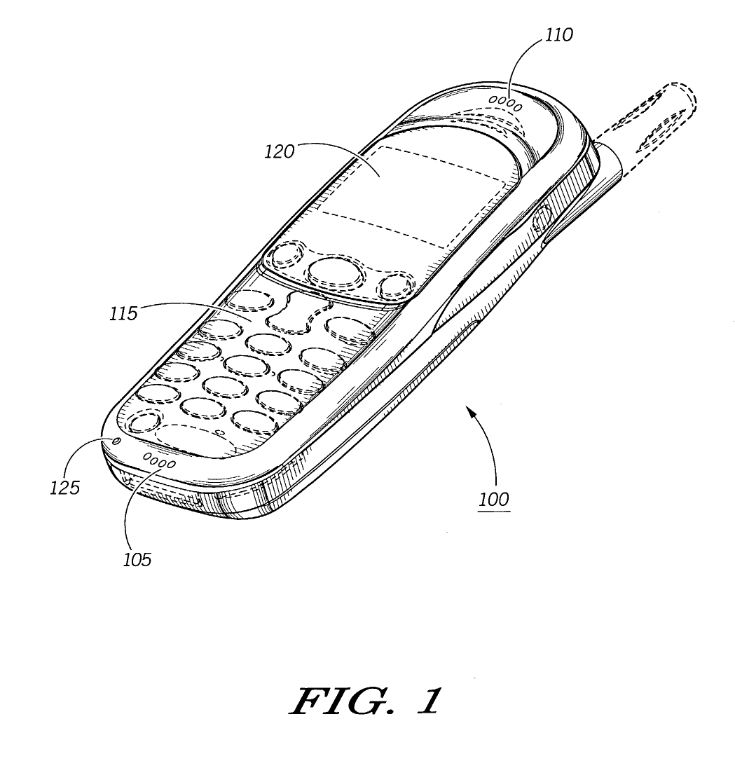

Referring to FIG. 1, an exemplary communication device 100 is shown. The communication device 100, for example, is a voice communication device. The communication device 100, for example, can be a cellular telephone (as illustrated), a cordless telephone, a mobile telephone, a wired landline telephone, or a personal communicator. In the following description, the term “communication device” refers to any of the communication devices mentioned above or an equivalent.

The communication device 100 preferably includes a microphone 105, an earpiece 110, a keypad 115, a display 120, and a sensor 125. The sensor 125, in accordance with one embodiment of the present invention, is proximately located with the microphone 105, as illustrated. Alternatively, the sensor 125, in accordance with another embodiment of the present invention, is proximately located with the earpiece 110. (not shown) The microphone 105 converts an acoustic input signal received from a voice transmission to the communication device 100 into an electric input signal. The earpiece 110 converts an electric output signal into an acoustic output signal transmitted from the communication device 100 to be heard by the listener of the communication device 100. The keypad 115 allows the user of the communication device 100 to enter data such as phone numbers and text memos. The display 120 provides visual information by displaying data such as one or more communication messages, phone numbers, caller identifications, graphic images, and the like. The sensor 125 utilizes one or more sensing mechanisms such as a temperature sensing mechanism, a proximity sensing mechanism, an acoustic pressure sensing mechanism, and the like to determine the positioning of the communication device 100 in relation to a device user. The sensor 125 is preferably coupled to a sensing circuit (not shown) which receives signals from the sensor 125 and provides control to various operational blocks of the communication device 100.

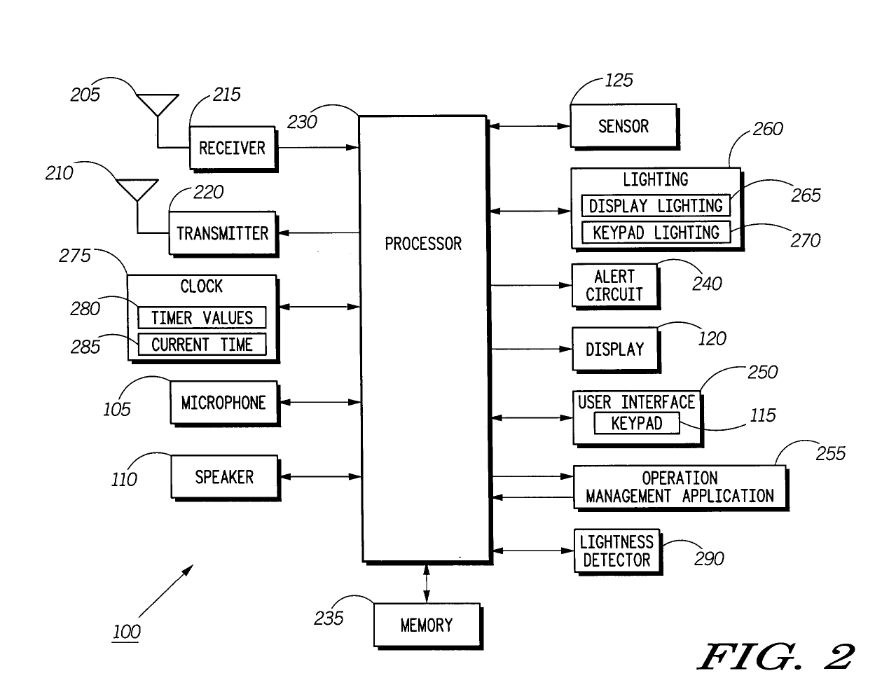

FIG. 2 is an electronic block diagram of a communication device in accordance with the present invention. The communication device, for example can be the communication device 100 as illustrated in FIG. 1 or an equivalent. As illustrated, the communication device 100 preferably includes a first antenna 205, a second antenna 210, a receiver 215, a transmitter 220, a processor 230, a memory 235, an alert circuit 240, the display 120, a user interface 250, such as the keypad 115, a lighting mechanism 260, and an operation management application 255.

The first antenna 205 intercepts transmitted signals from a communication system. The first antenna 205 is coupled to the receiver 215, which employs conventional demodulation techniques for receiving the communication signals. Coupled to the receiver 215, is the processor 230 utilizing conventional signal-processing techniques for processing received messages. It will be appreciated by one of ordinary skill in the art that additional processors can be utilized as required to handle the processing requirements of the processor 230. The processor 230 decodes an address in the demodulated data of a received message, compares the decoded address with one or more addresses stored in the memory 235, and when a match is detected, proceeds to process the remaining portion of the received message.

To perform the necessary functions of the communication device 100, the processor 230 is coupled to the memory 235, which preferably includes a random access memory (RAM), a read-only memory (ROM), and an electrically erasable programmable read-only memory (EEPROM)(not shown). It will be appreciated by those of ordinary skill in the art that the memory 235 can be integrated within the communication device 100, or alternatively can be at least partially contained within an external memory such as a memory storage device.

Upon receipt and processing of a message or a call, the processor 230 preferably generates a command signal to the alert circuit 240 as a notification that the message has been received and stored or alternatively that a call is waiting for a response. The alert circuit 240 can include a speaker (not shown) with associated speaker drive circuitry capable of playing melodies and other audible alerts, a vibrator (not shown) with associated vibrator drive circuitry capable of producing a physical vibration, or one or more light emitting diodes (LEDs) (not shown) with associated LED drive circuitry capable of producing a visual alert. It will be appreciated by one of ordinary skill in the art that other similar alerting means as well as any combination of the audible, vibratory, and visual alert outputs described can be used for the alert circuit 240.

Upon receipt and processing of a message or a received call, the processor 230 preferably also generates a command signal to the display 120 to generate a visual notification. The display can be a liquid crystal display, a cathode ray tube display, one or more organic light emitting diodes, one or more LEDs, a plasma display, or an equivalent. To facilitate utilization and visualization of the information on the display 120, the lighting mechanism 260 including display lighting mechanisms is coupled to the processor 230. For example, the lighting mechanism 260 can include a display lighting mechanism 265 for illuminating the display 120.

Preferably, the user interface 250 is coupled to the processor 130. The user interface 250 can include the keypad 115 such as one or more buttons used to generate a button press or a series of button presses. The user interface 250 can also include a voice response system or other similar method of receiving a manual input initiated by the device user. The processor 230, in response to receiving a user input via the user interface 250 performs commands as required. To facilitate utilization and visualization of the user interface 250, the lighting mechanism 260 including user interface lighting mechanisms is coupled to the processor 230. For example, the lighting mechanism 260 can include a keypad lighting mechanism 270 for illuminating at least a portion of the keypad 115 as needed to facilitate the utilization of the keypad 115 in dark environments.

The transmitter 220 is coupled to the processor 230 and is responsive to commands from the processor 230. When the transmitter 220 receives a command from the processor 230, the transmitter 220 sends a signal via the second antenna 210 to the communication system.

In an alternative embodiment (not shown), the communication device 100 includes one antenna performing the functionality of the first antenna 205 and the second antenna 210. Further, the communication device 100 alternatively includes a transceiver circuit (not shown) performing the functionality of the receiver 215 and the transmitter 220. It will be appreciated by one of ordinary skill in the art that other similar electronic block diagrams of the same or alternate type can be utilized for the communication device 100.

In accordance with the present invention, the communication device 100 includes the sensor 125 coupled to the processor 230. The sensor 230 detects the communication device's proximity to the device user. The sensor 125, for example, can be a microphone proximately located at the earpiece 110 of the communication device 100 or alternatively can be a microphone connected via a transmission line to the earpiece 110. It will be appreciated by one of ordinary skill in the art that, in accordance with the present invention, the sensor 125 can be located within the communication device 100 as mentioned herein or an equivalent. The sensor 125, in one embodiment, monitors a frequency response by measuring an acoustic pressure. One of ordinary skill in the art will recognize that the acoustic pressure varies as the communication device 100 is brought closer or farther away from the ear of the user of the communication device 100. The sensor 125 is coupled to and feeds a response signal to the processor 230 which preferably includes software and hardware to process the information received from the sensor 125. Similarly, the sensor 125 can utilize temperature sensing or other similar means to determine the position of the communication device in relation to the device user.

The communication device 100 preferably also includes a lightness detector 290 coupled to the processor 230 to determine the environmental lighting conditions (i.e. a lightness level). The lightness detector 290, for example, can be a photo sensor. A photo sensor is an electronic component that detects the presence of visible light, infrared transmission (IR), and/or ultraviolet (UV) energy. Most photo sensors consist of semiconductor having a property called photoconductivity, in which the electrical conductance varies depending on the intensity of radiation striking the material. The lightness detector 290 provides a lightness signal to the processor 230 identifying the current level of light surrounding the lightness detector 290.

To provide the communication capabilities of the communication device 100, the microphone 105 and the earpiece 110 are preferably coupled to the processor 230. The device user is provided with audio information via the earpiece 110 from the processor 230 and the device user's audio information is processed via the microphone 105 through the processor 230.

The communication device 100 preferably further includes a clock 275 coupled to the processor 230. The clock 275 provides timing for the processor 230. The clock 230 can include a current time 285 for use in the operation of the communication device 100 and particularly for use in the operation of the operation management application 255. The clock 275 also provides one or more timing values 280 for automatically turning on and off various functions of the communication device 100.

In a preferred embodiment, the communication device 100 includes the operation management application 255. The operation management application 255 can be hard coded or programmed into the communication device 100 during manufacturing, can be programmed over-the-air upon customer subscription, or can be a downloadable application. It will be appreciated that other programming methods can be utilized for programming the operation management application 255 into the communication device 100. It will be further appreciated by one of ordinary skill in the art that operation management application 255 can be hardware circuitry within the communication device 100.

The operation management application 255 operates using a plurality of user preferences which can be manually set by the user of the communication device 100, or can be preprogrammed into the communication device 100. Preferably, the plurality of user preferences can be changed as desired by the user of the communication device 100. The plurality of user preferences preferably includes lighting functionality preferences and display activation preferences. The operation management application 255 further utilizes the sensing information received from the sensor 125 via the processor 230 to determine whether the display lighting 265, the keypad lighting 270, the display 120, and other functional blocks should be in an active or inactive state. For example, the user preferences can be set such that when the communication device 100 is near the device user's ear, (i.e. based on the received sensor signal), the display 120, the display backlight 265, and the keypad lighting 270 can be turned off for a predetermined period of time. Such operation improves battery life by reducing overall current drain. Similarly, when the communication device 100 is taken away from the user's ear (i.e. based on the received sensor signal) the display 120, the display lighting 265, and the keypad lighting 270 can be automatically activated and turned on a predetermine period of time allowing the user to clearly see the display 120 and the keypad 115 without having to “blindly” press any buttons. The operation management application 255 further utilizes the lightness information from the lightness detector 290 to determine whether or not lighting is necessary based on the surrounding lighting of the environment. It will be appreciated by one of ordinary skill in the art that the user preferences can include separate settings for each of the operational blocks of the communication device 100. For example, the display 120 can be set for one operation and the display lighting 265 another.

By utilizing the sensor information as described above, the operation management application 255 provides the device user a more controlled operational environment. For example, controlling the operation of the display 120 and the lighting mechanism 260 allows the device user to successfully end a call by taking the communication device 100 away from their ear and pressing the appropriate button by clearly seeing the illuminated display 120 and the keypad 115. Similarly, while still on a call, the device user will be able to briefly look at the display 120 (e.g., to determine battery status, signal strength, etc) of the communication device 100 without having to press any buttons and create any undesirable tones the party on the other end of the call will hear.

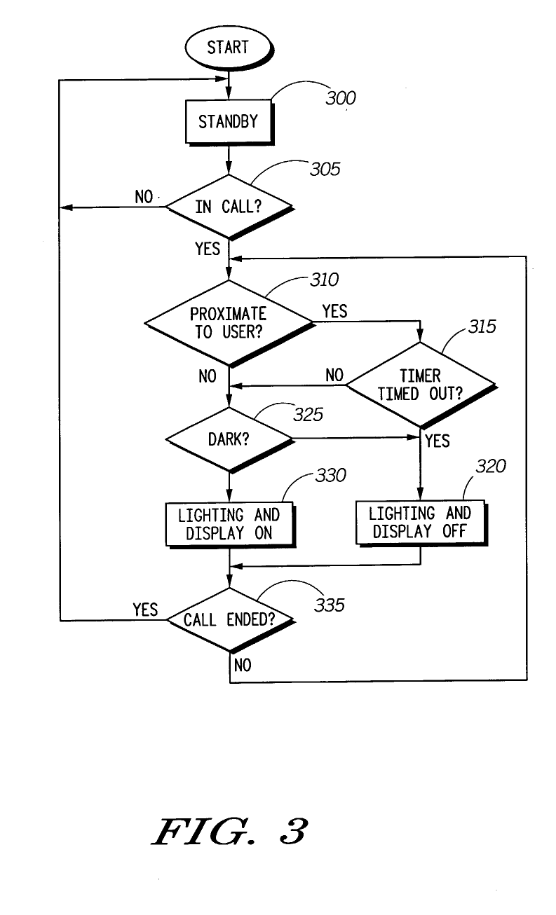

FIG. 3 is a flowchart illustrating one embodiment of the operation of the communication device 100 in accordance with the present invention. Specifically, FIG. 3 illustrates an exemplary embodiment of the management of the various lighting and display operations of the communication device 100 in relation to the proximity of the communication device 100 to the device user.

The process begins with Step 300 in which the communication device 100 is in standby mode. Standby mode runs the communication device 100 with minimal power to conserve battery life. Next, in Step 305, the process periodically checks if the communication device 100 is communicating within a call. When the communication device 100 is not in a call, the process returns to the standby mode of Step 300. When the communication device 100 is communicating within a call in Step 305, the process continues with Step 310 in which the process determines whether or not the communication device 100 is proximate to the device user. For example, the processor 230 checks the signal from the sensor 125 to determine the distance between the communication device 100 and the device user. In Step 315, when the communication device 100 is proximate to the device user, the process determines whether a preset timer has timed out. For example, a timer value can be set when the call is initiated. In Step 320, when the timer has timed out, the various lighting mechanisms and the display are turned off. For example, dependent upon the user preferences set within the communication device 100, all lighting or a subset of lighting and/or the display 120 can be turned off by the processor 230 in response to a command from the operation management application 255.

When the communication device 100 is not proximate to the device user in Step 310 or when the timer has not timed out in Step 315, the process continues with Step 325. At Step 325, the process determines whether or not the surrounding environment is dark enough to require lighting. For example, the processor 230 compares the lighting signal received from the lightness detector 290 to a preset light level. When the environmental light is not below the preset light level (i.e. it is not dark outside) the process continues to Step 320. When the environmental light is darker than the preset light level, the process continues with Step 330 in which the various lighting and/or the display 120 are either turned on or remain in an active condition if already turned on. For example, the user preferences can include which lighting or other functional blocks should remain active. The processor 230 can activate such operational blocks in response to a command from the operation management application 255. Next, in Step 335, or after Step 320 is completed, the process determines whether or not the current call has ended. When the call has not ended, the process cycles back to Step 310 and checks for proximity of the communication device 100 to the device user. When the call has ended in Step 335, the process cycles back to Step 300 in which the communication device 100 is in standby mode.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A communication device comprising:
a sensor for determining a position of the communication device in relation to a device user;
a user interface for receiving user inputs from the device user; and
a lighting mechanism for illuminating the user interface when the position determined by the sensor is greater than a predetermined distance.

2. A communication device as recited in claim 1 further comprising:
a microphone, wherein the sensor is proximately located with the microphone.

3. A communication device as recited in claim 1 further comprising:
an earpiece, wherein the sensor is proximately located with the earpiece.

4. A communication device as recited in claim 1, wherein the user interface comprises a keypad and further wherein the lighting mechanism comprises a keypad lighting mechanism for illuminating at least a portion of the keypad.

5. A communication device as recited in claim 1 further comprising:
a display for providing visual information, wherein the lighting mechanism comprises a display lighting mechanism for illuminating the display.

6. A communication device as recited in claim 5, wherein the display is activated when the position determined by the sensor is greater than a predetermined distance.

7. A communication device as recited in claim 1 wherein the sensor utilizes one or more sensing mechanisms selected from a group consisting of a temperature sensing mechanism, a proximity sensing mechanism, and a acoustic pressure sensing mechanism.

8. A communication device as recited in claim 1 further comprising:
a lightness detector for determining a lightness level, wherein the lighting mechanism further illuminates the user interface when the lightness level is below a predetermined level.

9. A communication device as recited in claim 1 further comprising:
an operation management application programmed to:
receive the sensing information from the sensor, and
compare the sensing information to a plurality of user preferences, and
change the state of the lighting mechanism based on the comparing step.

10. A communication device as recited in claim 9 further comprising:
a display, wherein the operation management application is further programmed to:
change the state of the display based on the comparing step.

11. A method for automatic display and lighting activation within a communication device, the method comprising the steps of:
initiating a communication call;
determining a position of the communication device in relation to a device user;
activating a lighting mechanism when the position is greater than a predetermined distance.

12. The method of claim 11 further comprising the step of:
activating a display when the position is greater than a predetermined distance.

13. The method of claim 11 further comprising the steps of:
measuring a lightness level surrounding the communication device prior to the activating step;
proceeding to the activating step when the lightness level is below a predetermined level; and
inactivating the lighting mechanism when the lightness level is above a predetermined level.
